(19) United States
(12) Patent Application Publication
(10) Pub. No.: US 2011/0226103 A1
(43) Pub. Date: Sep. 22, 2011

(54) Vaccum appliance attachment for cutting

(76) Inventor: Frank Joeph Caruso, Racine, WI (US)

(21) Appl. No.: 12/661,652

(22) Filed: Mar. 20, 2010

(51) Int. Cl. B26D 7/06

(52) U.S. Cl. 83/24; 83/100

(57) ABSTRACT

A cutting attachment 1 is mounted to the distal end of a vacuum hose extending from a conventional vacuum appliance. The vacuum appliance is operated, causing vacuum pressure and resultant suction through the vacuum hose to occur. The motor assembly 3 of the cutting attachment 1 is activated to cause the blade assembly 9 to rotate. The user then holds the cutting attachment 1 and manipulates it by hand in order to pass the rotating blade assembly 9 over and against a material or article, such as a plant, to be cut. As pieces are cut and severed they are immediately pulled into the nozzle opening 11 by the suction force created by the vacuum appliance.

### RELATED APPLICATIONS

None.

### TECHNICAL FIELD

The present invention relates to accessories for appliances and associated methods of use and, more particularly, to accessories and associated methods of use for attachments that are adapted to attach to a vacuum appliance for performing one or more specific functions.

### BACKGROUND OF THE PRESENT INVENTION

Various, known vacuum appliances, whether portable or stationary, are provided with one or more attachments that enhance vacuum appliances or that perform one or more functions that are not otherwise associated with vacuum appliances. For example, portable vacuum appliances often include a vacuum hose to which a variety of available nozzles each of different sizes and shapes are attachable and detachable for selective use wherein a specific nozzle size and shape is better suited than others for the type of debris being collected by the vacuum appliance, or the characteristics of the surface from which the debris is being collected. In another example, a commonly known vacuum appliance attachment is a powerized, rotating brush attachment that includes a powered, rotating brush that physically brushes debris to enable it to be collected by the vacuum pressure of the appliance.

Various appliances that cut material are suited for coupling with vacuum appliances in order to immediately collect, as it is being cut, the material that is being cut. One form of known examples include hair clippers for cutting hair that have an integrated vacuum system for collecting debris, i.e., freshly cut hair clippings, as they are cut. Similarly, certain shearing appliances for grooming or shaving livestock integrate vacuum systems.

Common shortcomings of many known appliances that integrate vacuum systems with additional functioning components include complex construction, relatively high costs, and limitation due to dedicated components. If, for example, the vacuum system fails but the other components do not, the appliance is rendered less functional, if not useless, and repair or replacement must be undertaken. Also, a dedicated vacuum can be used to collect debris that is produced by or accessible by the shared components and, thus, more general use of the vacuum system is not possible or is limited.

### OBJECTS OF THE PRESENT INVENTION

It is an object of the present invention to integrate a vacuum appliance with a cutting appliance.

It is another object of the present invention to integrate a vacuum appliance with a cutting appliance in a manner that is selectively coupled or de-coupled.

It is yet another object of the present invention to provide a cutting appliance attachment for use with an existing vacuum appliance wherein the cutting appliance attachment is selectively and conveniently attachable to and detachable from the vacuum appliance.

It is yet another object of the present invention to provide an associated method of using a cutting appliance attachment with an existing vacuum appliance wherein the cutting appliance attachment is selectively and conveniently attachable to and detachable from the vacuum appliance.

These and other objects that are inherent are achieved by the present invention described herein.

### SUMMARY OF THE PRESENT INVENTION

The present invention is directed to an attachment adapted to be attached to a conventional vacuum appliance, wherein the attachment includes a motorized, rotating blade assembly for cutting material into debris, wherein the debris is immediately collected by the vacuum while both are operating simultaneously. The attachment includes a motorized output shaft that drives a belt and a driven gear which, in turn, rotationally drives a blade assembly. The blade assembly is rotationally mounted within a nozzle-like housing that is open at a first end for connecting to a vacuum appliance hose and that is open at a second end for establishing communication between the vacuum appliance's vacuum chamber and the surrounding environment. In operation, the vacuum appliance is operated in its usual manner while the attachment is connected to the end of the vacuum appliance hose. The attachment is operated to cause the blade assembly to rotate thereby cutting debris which is immediately collected into the vacuum appliance's vacuum chamber via the vacuum hose.

### BRIEF DESCRIPTION OF THE DRAWINGS

FIG. 1 is an isometric view of a preferred embodiment of the present invention.

FIG. 2 is a front of a preferred embodiment of the present invention.

FIG. 3 is a front, sectional view of a preferred embodiment of the present invention.

FIG. 4 is a top view of a preferred embodiment of the present invention.

FIG. 5 is a top, sectional view of a preferred embodiment of the present invention.

FIG. 6A is a side view of a preferred embodiment of the present invention.

FIG. 6B is a side view of a preferred embodiment of the present invention showing certain components in phantom for illustrative purposes.

FIG. 7 is a partial, side, sectional view of a preferred embodiment of the present invention.

FIG. 8 is an isometric, partial sectional view of a preferred embodiment of the present invention.

FIG. 9 is an isometric, exploded view of a preferred embodiment of the present invention.

### DESCRIPTION OF THE PREFERRED EMBODIMENT

The present invention apparatus and method are described with respect to cutting or trimming bushes or hedges and collecting the clippings or debris from the cutting or trimming as an example of only one of various possible uses and, therefore, the present invention is not limited to such use. The presently described apparatus and method may be used for cutting a variety of materials or articles and collecting the resultant debris.

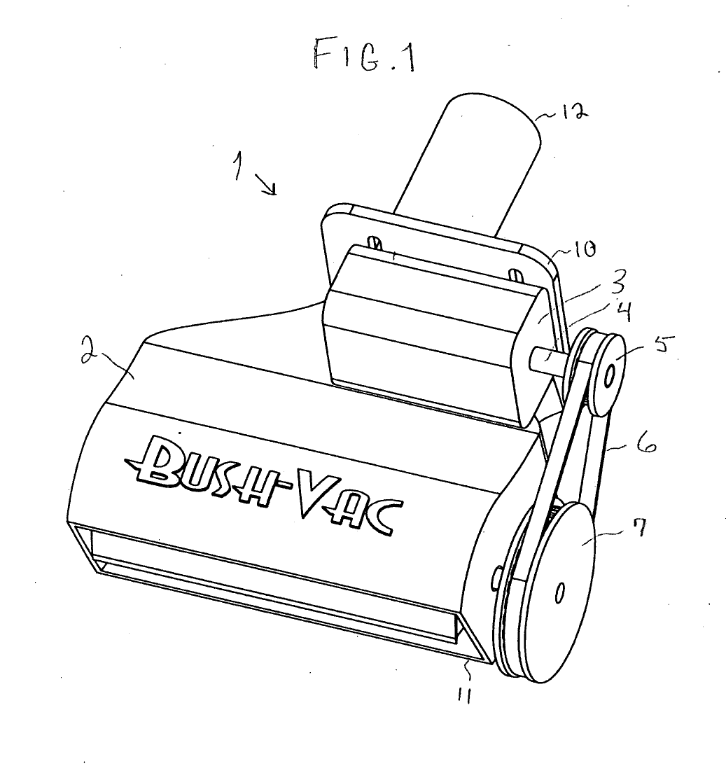

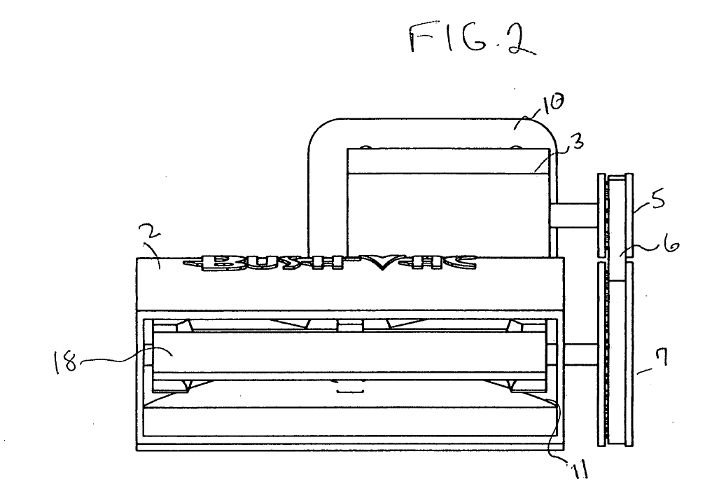

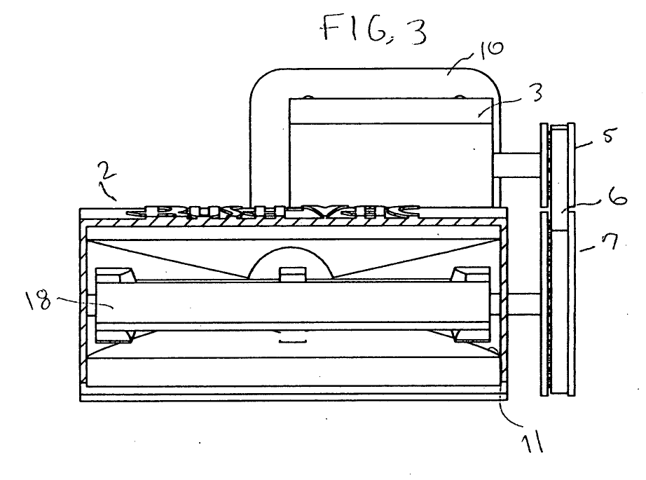

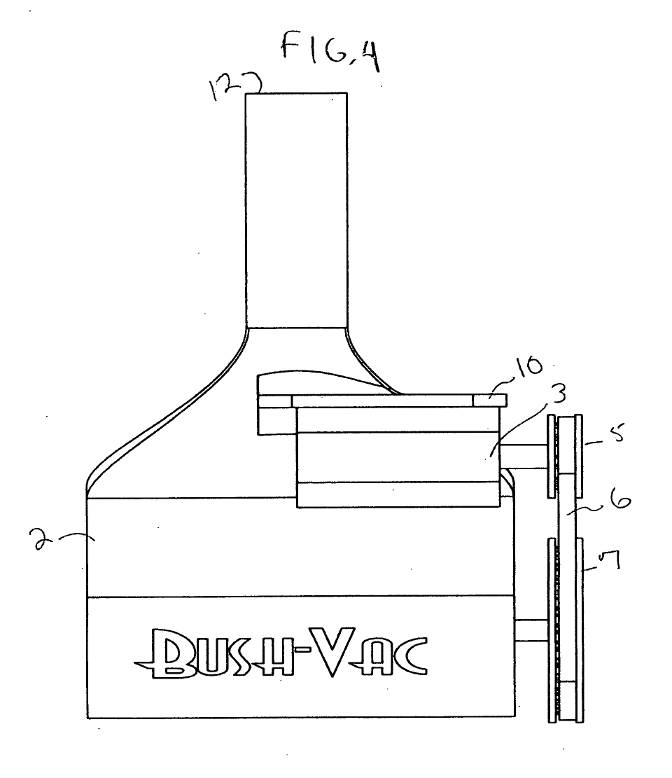

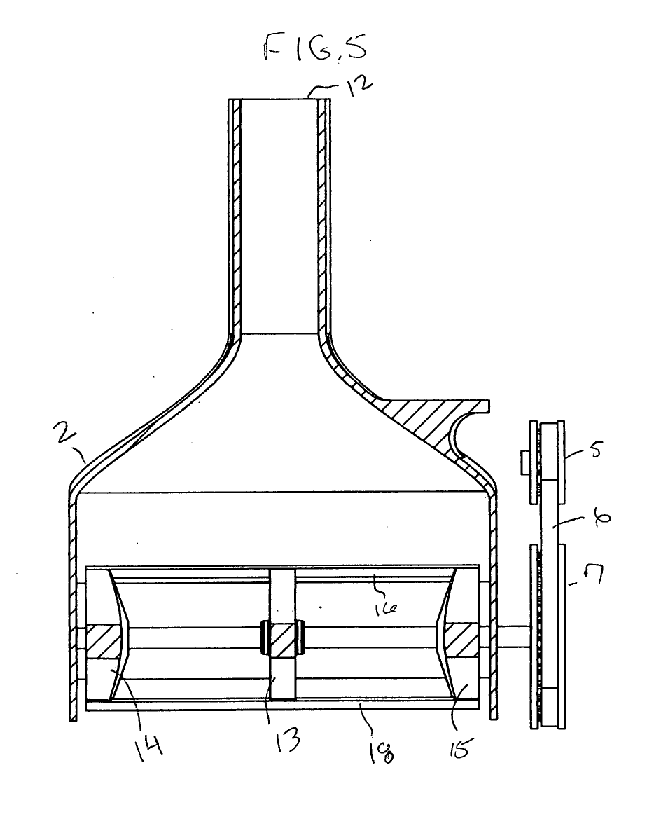

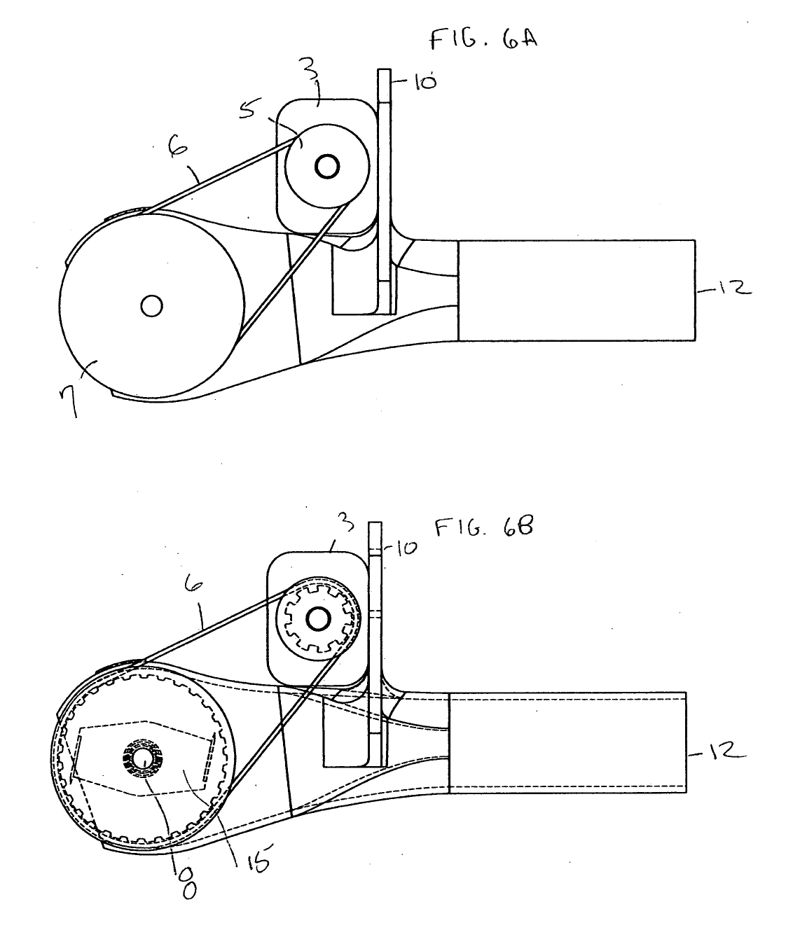

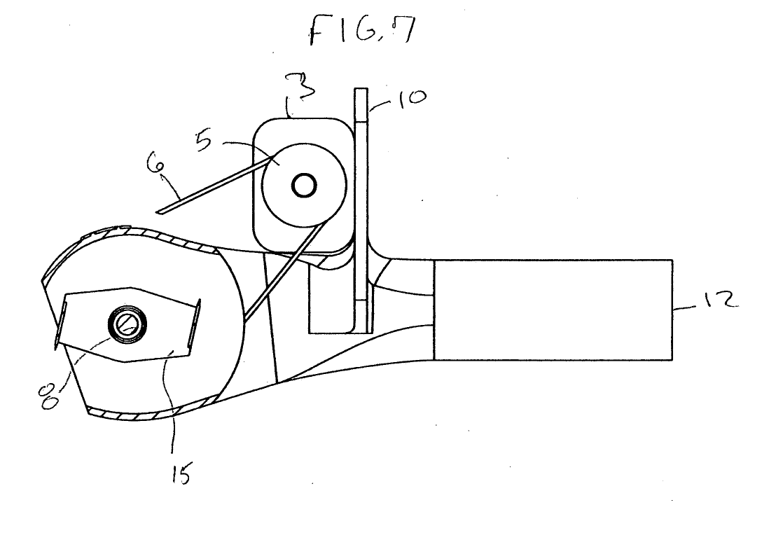

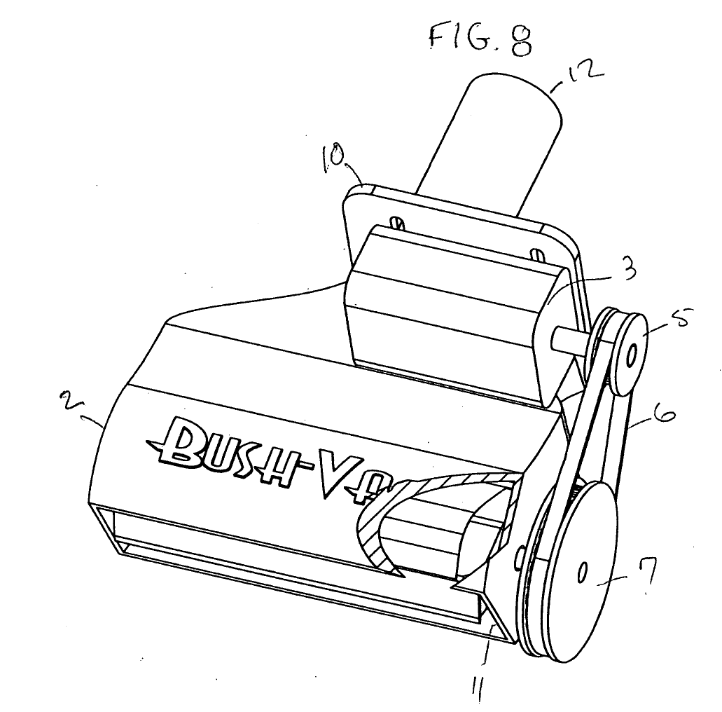

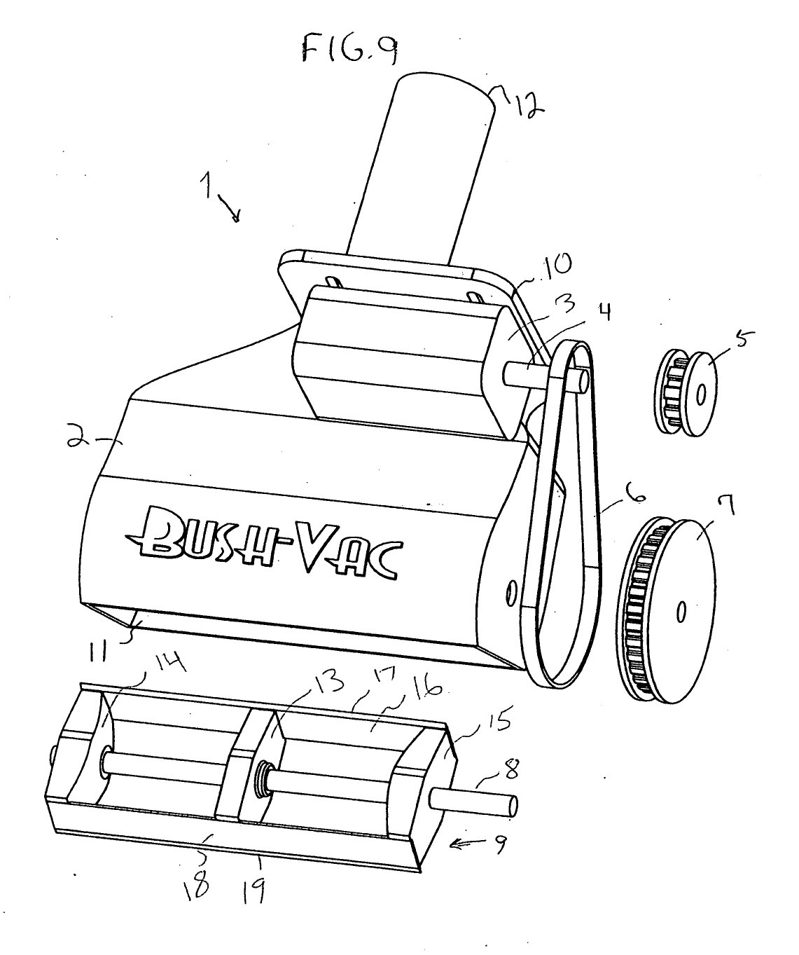

Referring to FIGS. 1-9, a preferred embodiment of the present invention cutting attachment 1 comprises a housing 2, a motor assembly 3, a drive shaft 4, a drive pulley 5, a drive belt 6, a driven pulley 7, a driven shaft 8, a blade assembly 9 and motor mount 10.

The housing 1 includes a distal end having a nozzle opening 11 and a proximal end having a hose attachment opening 12. The distal end is elongated to facilitate suction of debris into the nozzle opening 11 which is correspondingly elongated. The proximal end is generally round in cross section so that the hose attachment opening 12 is correspondingly round in cross section in order to mate with a conventional vacuum hose (not shown) of a conventional wet-dry style shop vacuum appliance. The housing 2 forms an interior space connecting the nozzle opening 11 to the hose attachment opening 12.

The motor assembly 3 comprises a housing, the exterior of which is shown in the drawing figures, and an electrically powered motor (not shown) contained therein, said motor being of a type generally known to those skilled in the art. The electric motor may be driven by battery power or rechargeable battery power, or it may be attached directly to an external electric power source via an extension cord (not shown). Alternatively, it may be electrically coupled to the vacuum appliance to share power passing through the vacuum appliance. The motor may also be driven by a non-electrical energy source and may comprise, for example, an internal combustion engine. The motor assembly 3 is mounted to a motor mount 10 in the form of a plate that is attached to the housing 2.

A drive shaft 4 extends from the motor assembly 3 and is rotationally driven by the motor. A drive pulley 5 is attached to the drive shaft 4 to rotate therewith. A drive belt 6 is coupled to the drive pulley 5 and coupled to a driven pulley 7. The driven pulley 7 is attached to a driven shaft 8. When the drive pulley 5 is rotated by the motor it causes the drive belt 6 to rotate the driven pulley 7 and the driven shaft 8.

A blade assembly 9 is attached to the driven shaft 8 for rotation therewith. The driven shaft 8 is mounted to the housing 2 by conventional means such as bearing surfaces or bearing assemblies (not shown) of a type generally known to those skilled in the art. The blade assembly 9 comprises a central hub 13 and a first end hub 14 and a second end hub 15. The hubs each are supported on the driven shaft 8 and each hub is attached at one end to a first blade 16 having a sharpened cutting edge 17, and at a second end to a second blade 18 having a sharpened cutting edge 19. Preferably, the blades 16 and 18 each have a length that is approximately the same as the length of the nozzle opening in order to optimize debris cutting and collection. Each blade 16, 18 are generally parallel to the other and generally parallel to the driven shaft 8. Rotation of the blades 16, 18 revolves about the driven shaft 8. It is advantageous that the blades 16, 18 are arranged to rotate in a non-planar fashion (i.e., such as a disc-type or propeller blade) and instead rotate in a paddle-wheel pattern, occupying an imaginary cylinder. The maximizes cutting surface length of the blades while minimizing the “footprint” or surface area of the nozzle opening 11 and while minimizing the overall size and volume of the attachment 1.

In operation, a cutting attachment 1 according to the present invention is mounted to the distal end of a vacuum hose extending from a conventional vacuum appliance. The proximal end hose attachment opening 12 is press-fitted telescopically to the vacuum hose, as is generally known when attaching conventional vacuum attachments. The vacuum appliance is operated, causing vacuum pressure and resultant suction through the vacuum hose to occur. The motor assembly 3 of the cutting attachment 1 is activated to cause the blade assembly 9 to rotate. The user then holds the cutting attachment 1 and manipulates it by hand in order to pass the rotating blade assembly 9 over and against bushes, shrubs, hedges and the like in order to trim or cut them. As they are cut and severed, pieces of debris, or clippings, are immediately pulled into the nozzle opening 11 by the suction force created by the vacuum appliance. They pass through the attachment 1 and the vacuum hose, and into the vacuum appliance debris chamber.

Although the preferred embodiment is described herein as being used with a conventional vacuum appliance, and may be used with portable household and commercial vacuum appliances, it is understood that the presently claimed invention may also be used in industrial and heavy machinery settings in which the vacuum system may be part of a much larger or fixed system. Furthermore, while the preferred embodiment contemplates cutting bushes, shrubs, hedges and the like, it is not limited to such and may be used for cutting a variety of plant forms including weeds and grass, as well as shearing fur from animals and for trimming non-living materials and things.

While the preferred embodiment of the invention has been described herein, various modifications may be made without departing from the scope of the presently claimed invention.

What is claimed is:

1. A cutting attachment for use with a vacuum appliance, said attachment comprising
a housing having a generally hollow interior;
a motor assembly;
a drive assembly coupled to said motor assembly;
a blade assembly rotationally mounted to said housing and adapted to be rotationally driven by said drive assembly;
an open nozzle end at a distal end of said housing and in communication with the interior of said housing; and
an open hose attachment end at a proximal end of said housing and in communication with the interior of said housing, and being adapted to attach to a hose of a vacuum appliance such that when said vacuum appliance is operated suction force is communicated to said nozzle end.

2. An attachment according to claim 1, wherein
said drive assembly comprises a drive shaft extending from and driven by said motor assembly, a drive pulley attached to said drive shaft, a drive belt coupled to said drive pulley, a driven pulley coupled to said drive belt, and a driven shaft attached to said driven pulley and rotationally mounted to said housing.

3. An attachment according to claim 1, wherein
said blade assembly comprises two generally parallel blades spaced from and generally parallel to said driven shaft.

4. An attachment according to claim 3, wherein
said blades rotate in a non-planar fashion.

5. A method of cutting and collecting debris, said method comprising
providing an attachment to the end of a vacuum hose, said attachment comprising a moving blade assembly;
operating a vacuum appliance to produce suction force through said vacuum hose;
rotating said blade assembly to cut material; and
collecting pieces of the cut material by suction force into said vacuum hose.

6. A method according to claim 5, wherein
said attachment comprises
a housing having a generally hollow interior;
a motor assembly;
a drive assembly coupled to said motor assembly;
a blade assembly rotationally mounted to said housing and adapted to be rotationally driven by said drive assembly;
an open nozzle end at a distal end of said housing and in communication with the interior of said housing; and
an open hose attachment end at a proximal end of said housing and in communication with the interior of said housing, and being adapted to attach to a hose of a vacuum appliance such that when said vacuum appliance is operated suction force is communicated to said nozzle end.
